(19) United States
(12) Patent Application Publication
(10) Pub. No.: US 2005/0258106 A1
(43) Pub. Date: Nov. 24, 2005

(54) Advanced automated control and feedback process for wastewater treatment

(76) Inventor: Donald E. Cape SR., Bozeman, MT (US)

Correspondence Address: DONALD E. CAPE, SR., 2020 CHARLOTTE STREET, BOZEMAN, MT, 59718, US

(21) Appl. No.: 10/851,759

(22) Filed: May 24, 2004

(51) Int. Cl. C02F 1/00

(52) U.S. Cl. 210/739

(57) ABSTRACT

This utility patent describes the use of proprietary software created for the wastewater treatment process. It describes how the software is used throughout the process flow, showing its measurement and monitoring power to create results previously unavailable by current available methods. Areas within the process flow, where the proprietary software is added, are described showing how the software is used to enhance and control the operation of wastewater treatment systems. The utility patent describes the interaction between the processing and software to produce high quality results.

The basic method used for treating wastewater in an activated sludge system is comprised of receiving wastewater in the first tank chamber (comminution), comminuting solids in the wastewater, mixing the wastewater with and without air, introducing a carbon source, conveying the wastewater to another baffled section of the tank (clarifier), allowing settling to occur, returning activated sludge, and discharging effluent.

Most aerobic treatment systems can reduce BOD and TSS levels within reasonable limits. To achieve a high degree of reduction requires the ability to control variables such as dissolved oxygen levels and batch timing processes. To reduce nutrients like total nitrogen levels in wastewater requires a higher level of control of air, mixing, timing, and a carbon source introduction. Major reduction of phosphorous in wastewater requires a coagulation and filtration process. A type of disinfection process is required to reduce coliform. As in any mechanical system the management of the wastewater plant requires a knowledgeable operator.

The general chemical reactions inherit with wastewater treatment relative to nitrogen are as follows: Raw sewage containing proteins and urea decays to ammonia, ammonia and water produce ammonium hydroxide, ammonia and oxygen produce nitrite and hydrogen, nitrite and oxygen combine to produce nitrate (nitrobacteria), nitrate and a carbon source produce nitrogen (facultative bacteria).

The Neptune Control System was developed to produce a high quality of effluent in all the desired parameters; BOD, TSS, Total Nitrogen, Phosphorous, and Coliform. Most wastewater treatment systems utilizing activated sludge recognize that control of air, mixing, timing, and return of activated sludge are necessary ingredients in the treatment of wastewater. The Neptune Control System enables the treatment process to perform at a superior level.

In addition to providing system control for a high level of effluent performance, the Control System collects and records data from all facets of the plant and relays to the operator potential alarm conditions that may require operator intervention.

### BACKGROUND OF INVENTION

This utility patent applies to the field of Wastewater Treatment. There are over 6000 patents listed relative to Wastewater Treatment and a handful related to the concept of this patent. What makes this patent unique is its use of Neptune control proprietary software created by Quality Water Systems. This software manages the quality and monitoring of the overall system producing results not capable of being produced without the software.

We have found no patents in our field that apply proprietary software, created and owned by an individual company, dedicated solely to the resulting purification and quality output of wastewater. However, similar non-Neptune proprietary software patents include numbers: U.S. Pat. Nos. 3,938,434, 4,122,013, 4,253,947, 4,322,296, 4,657,680, 5,268,094, 5,482,630, 5,540,840, 5,788,841, 6,034,873 and 6,689,274.

### BRIEF SUMMARY OF THE INVENTION

Before the Neptune proprietary software was created, performance measurement at all levels was manually intensive, requiring slow and error-prone feedback into the process. With this slow and many times inaccurate feedback and control system, it was impossible to create the type of quality that wastewater treatment systems required to successfully grow and expand an operation, while maintaining customer satisfaction for existing clients. The software that was programmed and is proprietary to Neptune flows through and supports the whole wastewater treatment process and changes the levels of water purity and with much more timely feedback from existing operational locations.

### DRAWINGS

Brief Description of Related Pictures

FIG. 1. Control Screen displaying edit procedures for master timing

FIG. 2. Control Screen displaying timing entry for aeration pumps

FIG. 3. Control Screen displaying timing entry for aeration valves

FIG. 4. Control Screen displaying timing entry for transfer pumps

FIG. 5. Control Screen displaying interactive capabilities of all pumps and valves

FIG. 6. Control Screen displaying ability to override discrete and analog inputs

FIG. 7. Control Screen displaying ability to select proper timing for carbon source

FIG. 8. Control Screen displaying ability to control all other system components

FIG. 9. Control Screen displaying calibration and editing of input variables

FIG. 10. Control Screen displaying operator interaction of potential alarms

FIG. 11. Entry Screen displaying internet capabilities

FIG. 12. Control Screen displaying Event reporting capabilities

FIG. 13. Control Screen displaying Periodic reporting capabilities

FIG. 14. Control Screen displaying graphic reporting capabilities

### DETAILED DESCRIPTION OF THE INVENTION

The basic method used for treating wastewater in an activated sludge system is comprised of receiving wastewater in the first tank chamber (comminution), comminuting solids in the wastewater, mixing the wastewater with and without air, introducing a carbon source, conveying the wastewater to another baffled section of the tank (clarifier), allowing settling to occur, returning activated sludge, and discharging effluent.

Most aerobic treatment systems can reduce BOD and TSS levels within reasonable limits. To achieve a high degree of reduction requires the ability to control variables such as dissolved oxygen levels and batch timing processes. To reduce nutrients like total nitrogen levels in wastewater requires a higher level of control of air, mixing, timing, and a carbon source introduction. Major reduction of phosphorous in wastewater requires a coagulation and filtration process. A type of disinfection process is required to reduce coliform. As in any mechanical system the management of the wastewater plant requires a knowledgeable operator.

The general chemical reactions inherit with wastewater treatment relative to nitrogen are as follows: Raw sewage containing proteins and urea decays to ammonia, ammonia and water produce ammonium hydroxide, ammonia and oxygen produce nitrite and hydrogen, nitrite and oxygen combine to produce nitrate (nitrobacteria), nitrate and a carbon source produce nitrogen (facultative bacteria).

The Neptune Control System was developed to produce a high quality of effluent in all the desired parameters; BOD, TSS, Total Nitrogen, Phosphorous, and Coliform. Most wastewater treatment systems utilizing activated sludge recognize that control of air, mixing, timing, and return of activated sludge are necessary ingredients in the treatment of wastewater. The Neptune Control System, in conjunction with the application of off-the-shelf components, enables the treatment process to perform at a superior level.

In addition to providing system control for a high level of effluent performance, the Neptune Control System collects and records data from all facets of the plant and relays to the operator potential alarm conditions that may require operator intervention.

The process and software controls enable residential wastewater treatment treated with an activated sludge system to produce a high quality effluent. The parameters of BOD, TSS, total kjeldahl nitrogen, nitrate N, phosphorous, and coliform bacteria are reduced to a level to comply with reclaimed water standards.

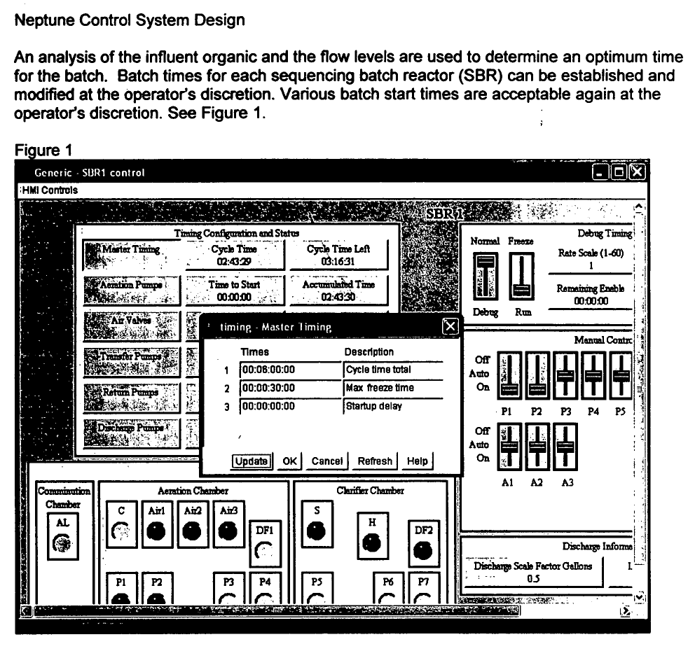

1. Neptune Control System, in conjunction with off-the-shelf components, enables precise master batch timing. (See FIG. 1)

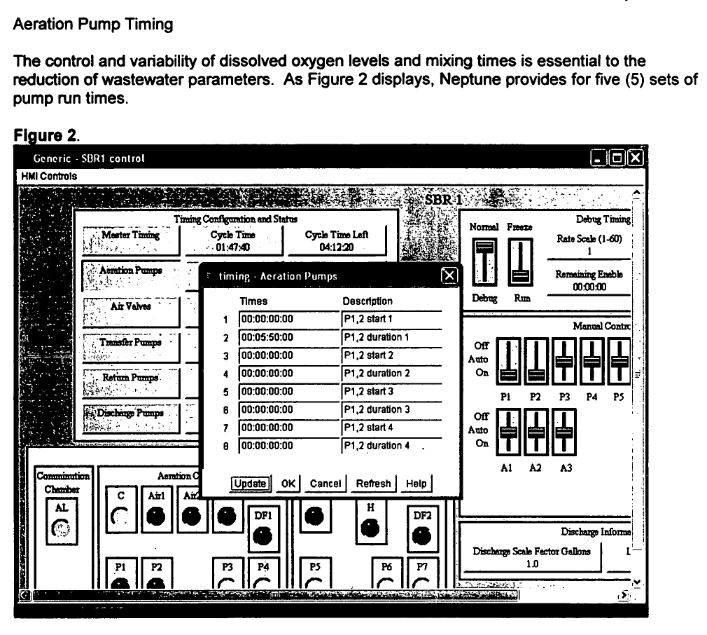

2. Dissolved oxygen levels are controlled using the Neptune Control System, in conjunction with off-the-shelf components, enabling multiple timing linked to aeration pumps. (See FIG. 2)

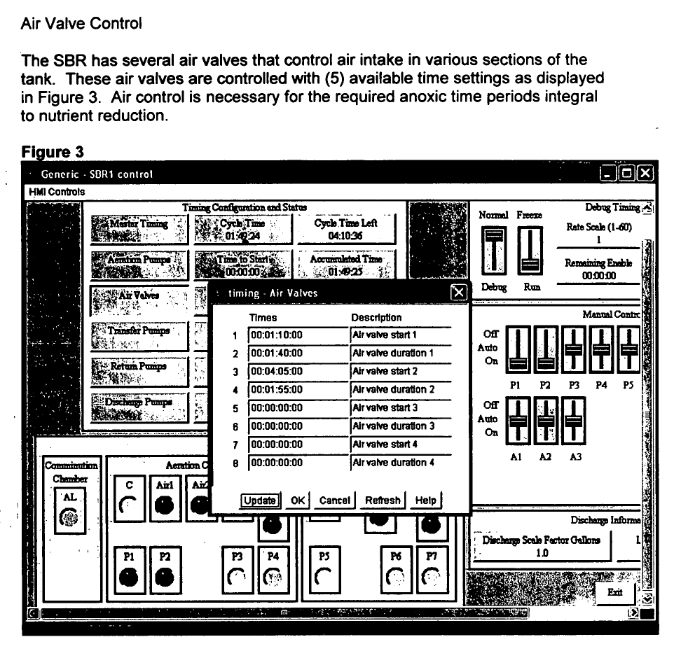

3. Dissolved oxygen levels are controlled using the Neptune Control System, in conjunction with off-the-shelf components, enabling multiple timing linked to air valves. (See FIG. 3)

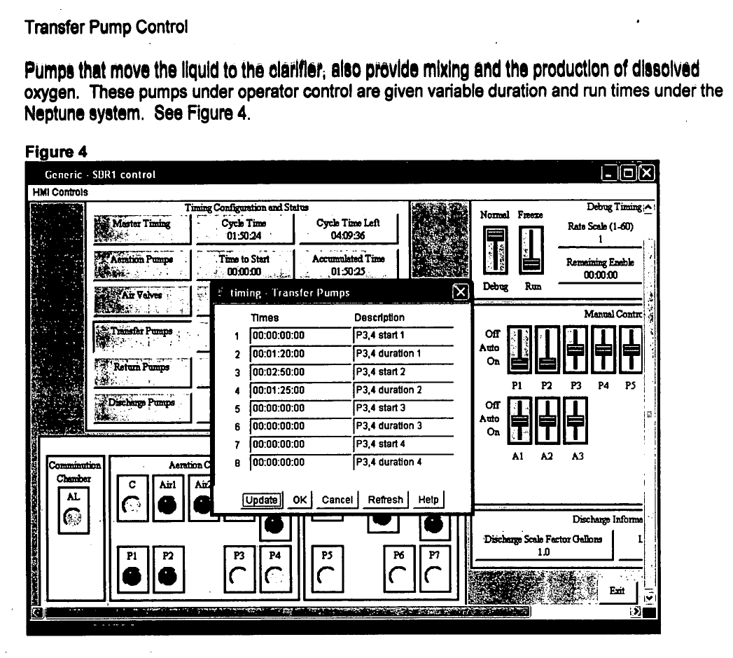

4. Dissolved oxygen levels are controlled using the Neptune Control System, in conjunction with off-the-shelf components, enabling multiple timing linked to transfer pumps. (See FIG. 4)

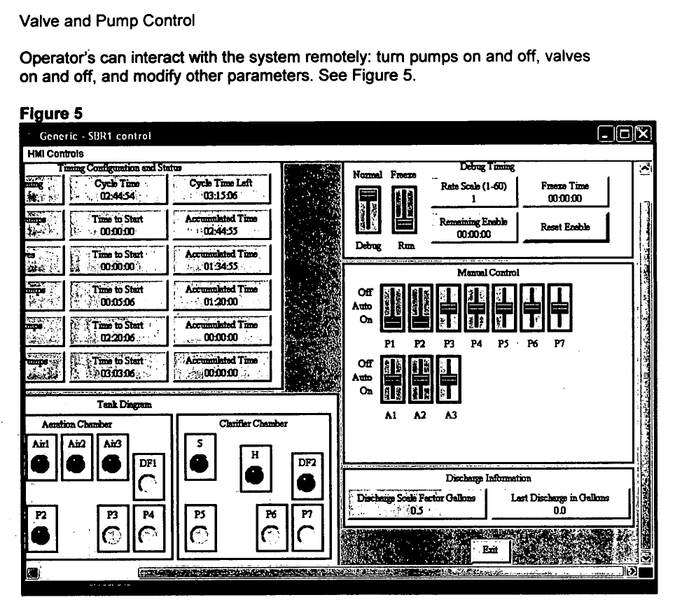

5. Neptune Control System, in conjunction with off-the-shelf components, provides for operator interface remotely to turn pumps on and off, valves on and off and modify process timing. (See FIG. 5)

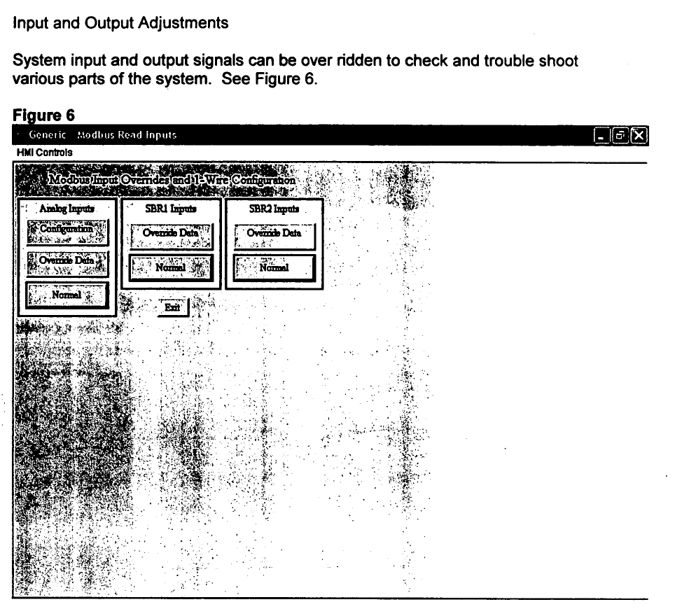

6. Neptune Control System, in conjunction with off-the-shelf components, enables operators to override various inputs and outputs for troubleshooting the system. (See FIG. 6)

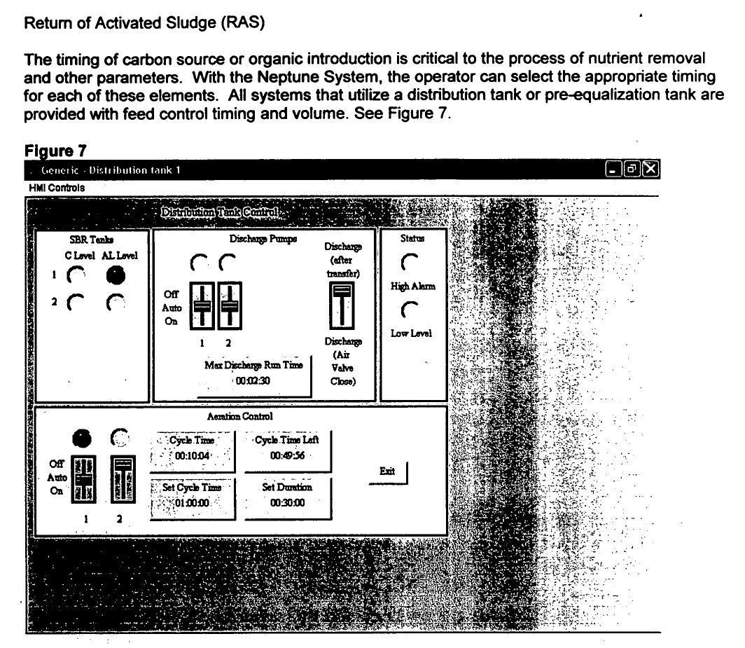

7. Multiple timing using the Neptune Control System, in conjunction with off-the-shelf components, enables the mixing action during anoxic time periods. (See FIG. 7)

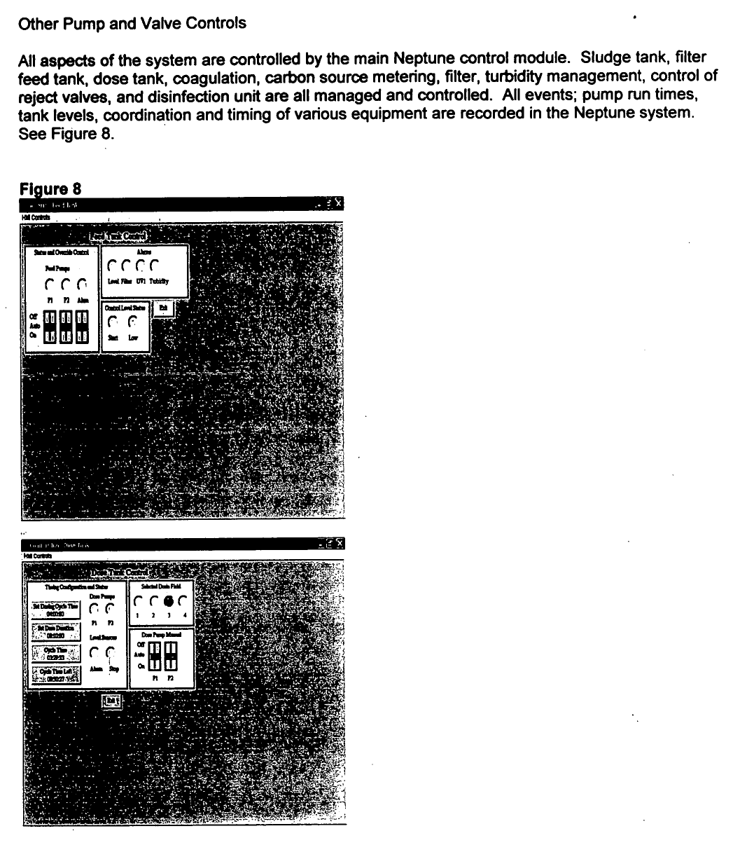

8. Multiple timing using the Neptune Control System, in conjunction with off-the-shelf components, enables the mixing action during nitrification time periods. (See FIG. 8)

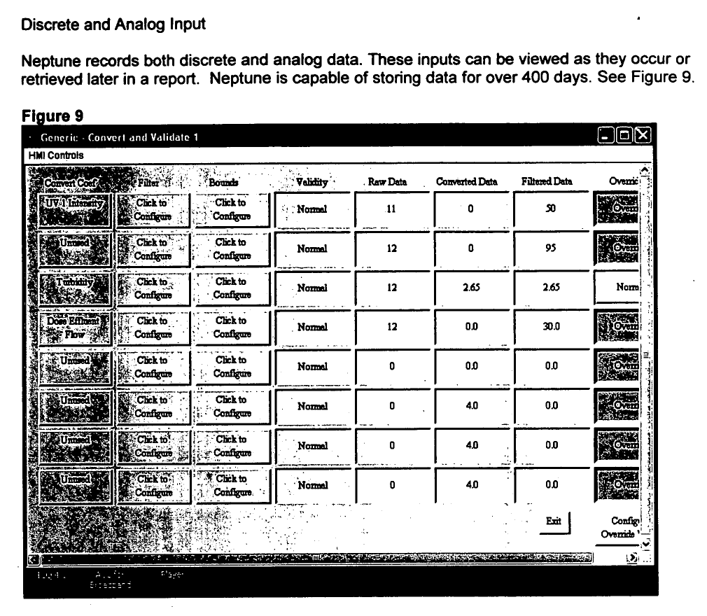

9. Neptune Control System, in conjunction with off-the-shelf components, enables organic loading to facilitate the nitrification and de-nitrification process. (See FIG. 9)

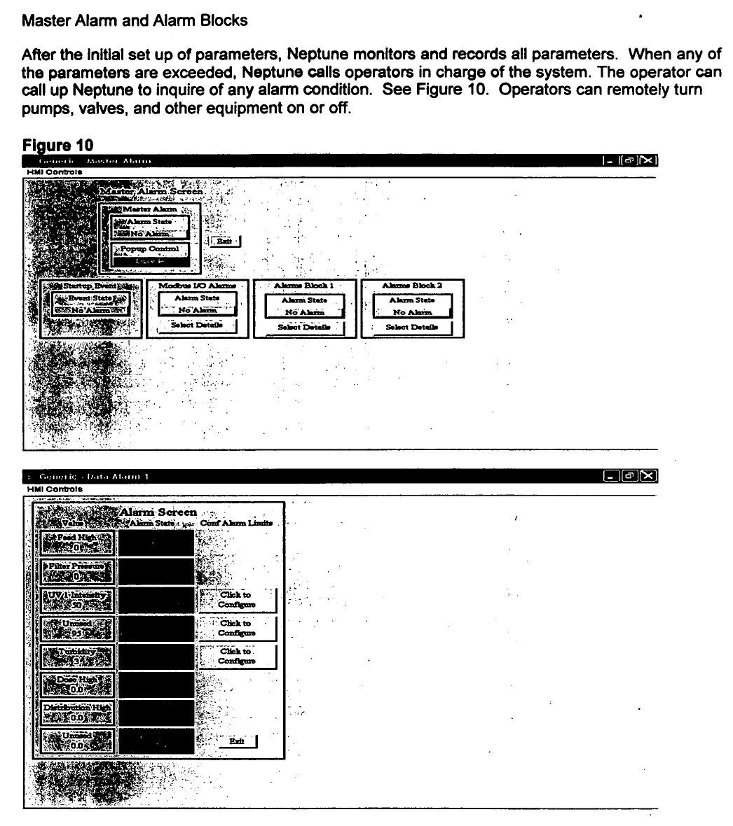

10. Neptune Control System, in conjunction with off-the-shelf components, provides continuous monitoring and recording of all equipment comparing results to initial parameters and making appropriate adjustments to stay within range. (See FIG. 10)

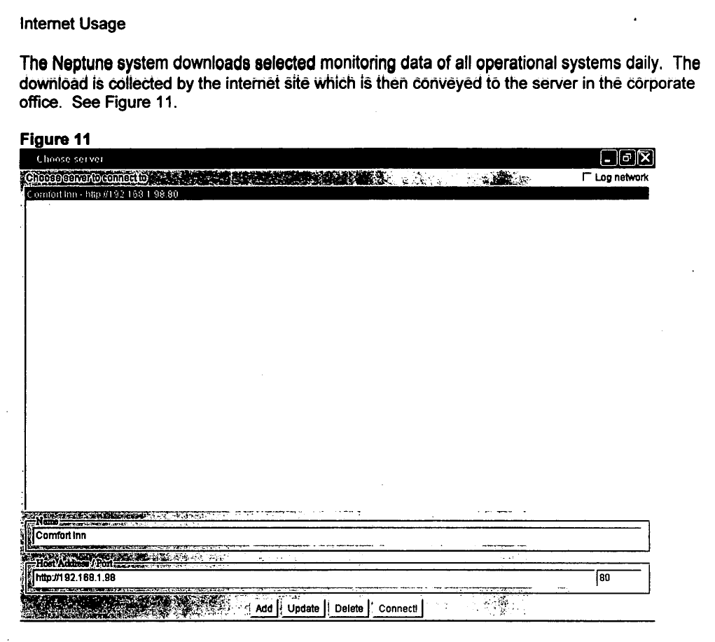

11. Neptune Control System, in conjunction with off-the-shelf components, control the introduction of an additional carbon source when necessary. (See FIG. 11)

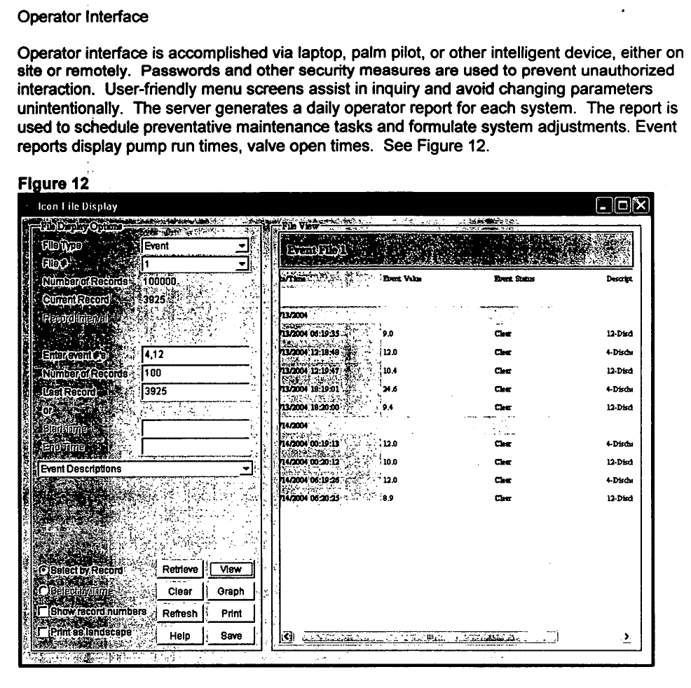

12. Neptune Control System, in conjunction with off-the-shelf components, provides remote access to authorized operators that can interact directly with wastewater treatment system equipment and process. (See FIG. 12)

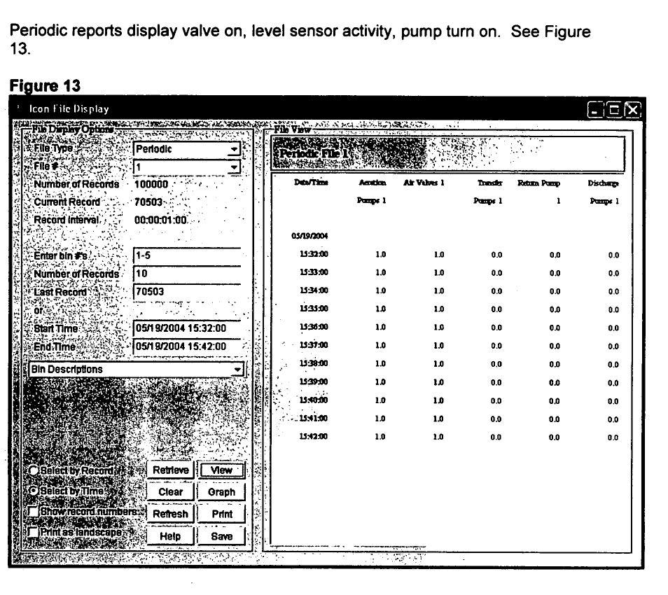

13. Neptune Control System, in conjunction with off-the-shelf components, records information (site access denied, I/O failure, power failure, high level in any system tank, turbidity out of range, UV intensity outside of range, filter pressure beyond range.) (See FIG. 13)

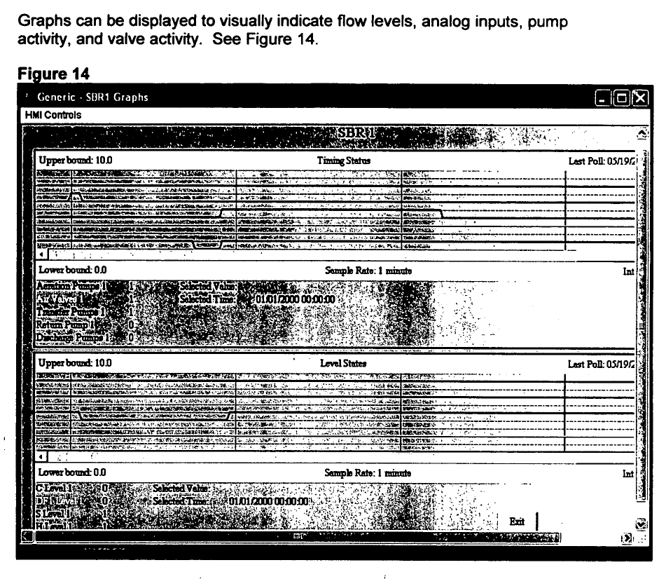

14. Neptune Control System, in conjunction with off-the-shelf components, records information (date, time, number of times turned on, total run time) for each valve, pump, and level sensor. (See FIG. 14)

15. Neptune Control System, in conjunction with off-the-shelf components, is internet based to enable system control from various locations. Neptune Control System, in conjunction with off-the-shelf components, provides polling to central web server allowing operators immediate access to system status
